(19) United States
(12) Patent Application Publication
(10) Pub. No.: US 2008/0043002 A1
(43) Pub. Date: Feb. 21, 2008

(54) SYSTEMS AND METHODS FOR ALTERNATIVE TO SERIAL PERIPHERAL INTERFACE COMMUNICATION IN DUMB DISPLAY DRIVER INTEGRATED CIRCUITS

(76) Inventors: John W. Kaehler, Lake Bluff, IL (US); Ken Foo, Gurnee, IL (US); Pinky Yu, Grayslake, IL (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 11/464,725

(22) Filed: Aug. 15, 2006

(51) Int. Cl. G09G 5/00

(52) U.S. Cl. 345/204

(57) ABSTRACT

An embodiment generally relates to a method of communicating with a plurality of registers in a display driver integrated circuit (IC). The method includes providing a data message and driving the data message over color select lines of the display driver IC in response to the display driver IC being in an overscan condition.

### FIELD

This invention relates generally to communication with peripherals, and more particularly, to an alternative to Serial Peripheral Interface (“SPI”) communication in dumb display driver integrated circuits (“ICs”).

### DESCRIPTION OF THE RELATED ART

Mobile terminals are a common electronic device. Mobile terminals are being introduced with new features such as video playback, music playback, image viewing, etc. These new features may have different display requirements. For example, displaying video may require a higher resolution versus displaying a contact list. There is some discussion regarding changing the mode of the liquid crystal display (LCD) of the mobile terminal in response to the type of application being executed.

Additional signal lines for the LCD may have to be added to the existing interface in order to implement some of the suggested changes. However, this is not a desirable solution because to add the signals lines would require changes to the packaging, an increase in pincount, and/or possible drop in reliability. Moreover, if read capability is required from the circuitry associated with LCD, this can contribute similarly to the disadvantages and/or drawbacks of adding signal lines to the existing interface.

### SUMMARY

An embodiment generally relates to a method of communicating with a plurality of registers in a display driver integrated circuit (IC). The method includes providing a data message and driving the data message over color select lines of the display driver IC in response to the display driver IC being in an overscan condition.

Another embodiment pertains generally to a method of communicating with a plurality of registers in a display driver IC. The method includes embedding a data message into a digital image to create an embedded image and transmitting the embedded image to the display driver IC. The method also includes processing the embedded image to transfer the data message to the respective registers of the display driver IC.

Yet another embodiment relates generally to a system for communication with a plurality of registers. The system includes a graphic processing unit configured to process digital images. The graphic processing unit is configured to embed a data message into a digital image to create an embedded image and transmit the embedded image. The system also includes a display driver IC configured to display images in response to data from the graphic processing unit, where the display driver IC is configured to process the embedded image to write the data message to the respective register of the plurality of registers in the display driver IC.

Yet another embodiment pertains generally to a system for communicating with a plurality of registers. The system includes a graphic processing unit (GPU) configured to process digital images and a display driver IC configured to interface with the GPU. The system also includes a standard interface conforming with at least one standard and providing a communication channel between the GPU and the display driver IC. The GPU is also configured to transmit a data message over color select lines of the standard interface to the display driver IC in response to the driver IC being in a predefined state.

Accordingly, communication with the dumb display drivers may be accomplished without the addition of serial lines in the existing interface. Thus, costs may be lowered because existing components may be used. Moreover, reliability may be improved as well as pin count, packaging costs, and board space being reduced.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an exemplary system configured to execute an embodiment;

FIG. 2 illustrates a more detailed schematic of a component configured to execute another embodiment;

FIG. 3 illustrates an exemplary display showing active scan region and overscan regions;

FIG. 4 illustrates a flow diagram in accordance with yet another embodiment;

FIG. 5 illustrates a flow diagram in accordance with yet another embodiment;

FIG. 6 illustrates a flow diagram in accordance with yet another embodiment; and

FIGS. 7A-B each depict data formats in accordance with embodiments of the present invention.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of systems that utilize serial communication, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments generally relate to systems and methods for communicating with dumb display driver integrated circuits (“ICs”) using existing hardware. More particularly, red, green and blue (RGB) data lines are used as a communication channel for the overscan regions. In current driver IC designs, the RGB signals are ignored when not scanning in the active area. This communication scheme can be initiated when both HSync and VSync signals are asserted as this will guarantee non-interference with the active area signals.

Another embodiment relates generally to communicating with registers in a dumb display driver IC using the active area scan. More particularly, data may be placed within a region of the active scan area of an LCD. The small number of registers in the driver IC and the relatively infrequent updates that are required for putting this information in the active scan area for one frame should not be noticeable to the user. This embodiment has the added advantage that no changes are needed to existing processors.

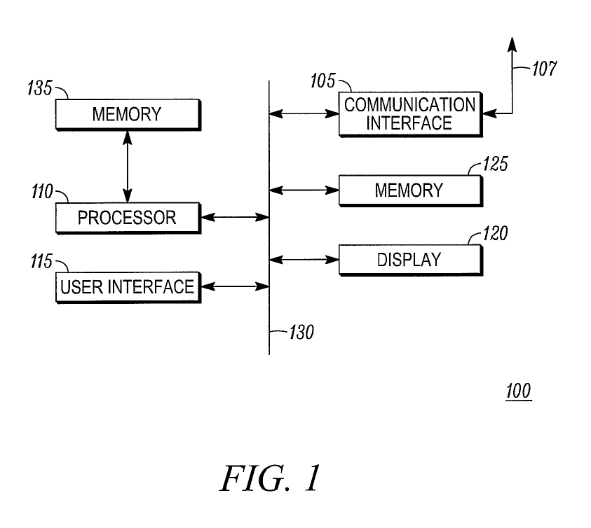

FIG. 1 illustrates an exemplary mobile terminal 100 that implements an embodiment. It should be readily apparent to those of ordinary skill in the art that the mobile terminal 100 depicted in FIG. 1 represents a generalized schematic illustration and that other components may be added or existing components may be removed or modified. Moreover, the mobile terminal 100 may be implemented using software components, hardware components, or combinations thereof.

As shown in FIG. 1, the mobile terminal (or mobile client) 100 may include a communication interface 105, a processor 110, a user interface 115, a display module 120, and memory 125. The wireless communication interface 105 (labeled as communication interface in FIG. 1) may be configured to facilitate communication over an air interface with a base station of a cellular network such as the iDen™ network. More particularly, the communication interface 105 may transmit and receive digital voice packets through a radio frequency (RF) antenna 107. The communication interface 105 may also be configured to interface with a shared bus 130. Transmitting voice packets may be forwarded from the user interface 115 to the communication interface 105 over the shared bus 130 as well as received voice packets forwarded to the user interface 115 over the shared bus 130.

Processor 110 may be configured to interface with the shared bus 130. The processor 110 may be configured to implement the software that embodies the functionality of the mobile terminal 100, which may be stored in processor memory 135 (labeled as memory in FIG. 1). Processor memory 135 may be programmable read only memory, flash memory or similar type of high speed persistent storage. Processor 110 may be an application specific integrated circuit, programmable field gate array, a microprocessor, digital signal processor or similar type of computing platform.

Memory 125 may be configured to store information for a user of the mobile terminal 100. For example, a contact list, downloaded music, digital images may be stored in memory 125. The memory 125 may be implemented using a persistent storage such as flash memory. In some embodiments, the storage function of the processor memory 135 may be provided by memory 125.

User interface 115 may be configured to interface with the shared bus 130. The user interface 115 may also be configured to facilitate interaction with a user. As such, the user interface 115 may include media input and output mechanisms. For example, to facilitate voice communications, these mechanisms may include a microphone (not shown) for receiving analog speech signals from a user and a speaker (not shown) for playing out analog speech signals to a user. Further, the mobile terminal 100 may include digital/analog media signals and digital representations of those signals.

The user interface 115 may also include a keypad (not shown). The keypad may be a Bell keypad, a QWERTY keyboard or similar mechanisms. In some embodiments, the keypad may be emulated on the display 120.

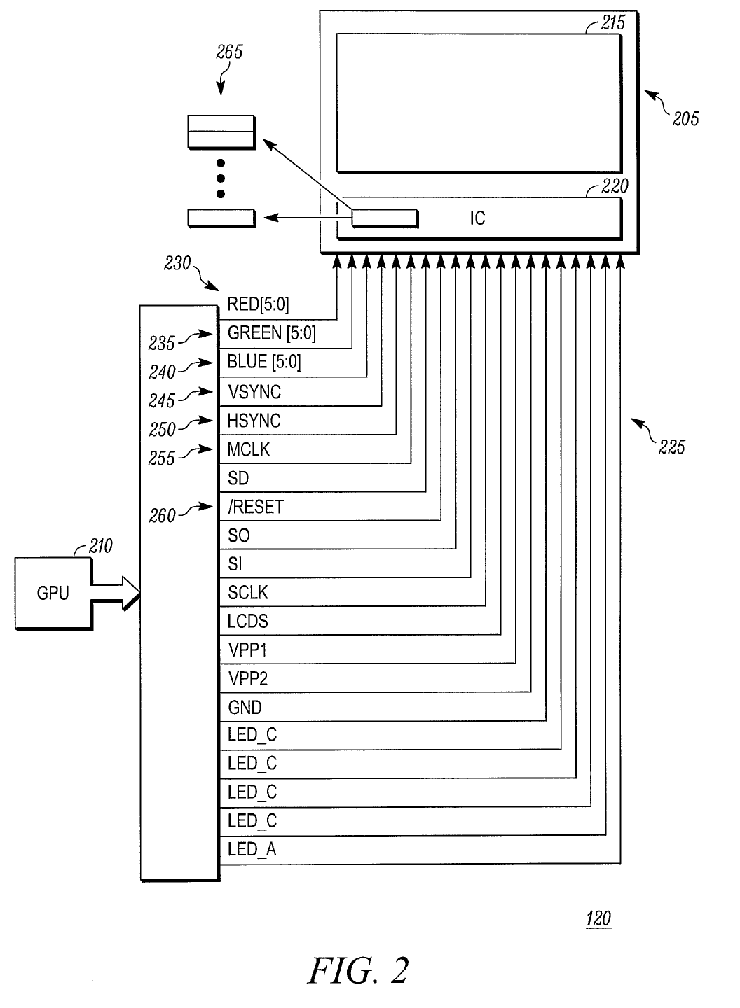

The display 120 may be configured to provide a visual interface for a user to interact with the mobile terminal. The display 120 may be implemented with a small form factor LCD. FIG. 2 illustrates a more detailed block diagram of the display 120. It should be readily apparent to those of ordinary skill in the art that the display 120 depicted in FIG. 2 represents a generalized schematic illustration and that other components may be added or existing components may be removed or modified. Moreover, the display 120 may be implemented using software components, hardware components, or combinations thereof.

As shown in FIG. 2, the display 120 may include an LCD 215 and a graphic processor unit (“GPU”) 210. The LCD 215 may comprise of an LCD array 215 and a dumb display driver IC 220. The LCD array 215 may be implemented as a small form factor LCD such as a TFT display with a resolution of 240×320. Other embodiments may use different transistor technology with varying resolutions.

The dumb display driver IC 220 may be configured to generate receive signals over the LCD interface 225 to display data such as an image, video, and/or text on the LCD array 215. The dumb display driver IC 220 may be configured to this data identically. Since the dumb display driver IC 220 has no memory, each frame of data can be different.

The GPU 210 may interface with the LCD interface 225 may include multiple signals which drive the dumb display driver IC 220. The GPU 210 may be configured to render two-dimensional images for the mobile terminal 100. As known to those skilled in the art, GPUs may be purchased from a variety of manufacturers such as Nvidia, Texas Instruments, ATI Technologies, Epson, Freescale, etc.

The LCD interface 225 may include synch signals 245, 250 and at least the red, green, blue lines (230, 235, and 240, respectively). In some embodiments, each color may comprise several lines. For a 16-bit color depth, there may be 5 lines for red, six lines for green and 5 lines for blue. Accordingly, there are 65,536 colors for the 16-bits (i.e., 2¹⁶=65,536). For an 18-bit color depth, there are six lines for each color yielding 262,144 possible different colors (i.e., 2¹⁸=262,144). The synch signals 245, 250 may include the vertical and a horizontal, respectively, synch signal as well as a clock signal 250 and a reset line 265. The RGB signal lines 230, 235, 240, respectively (or the color select lines) may be used by the GPU 210 to-set the appropriate color pixel level in the LCD array 215.

The dumb display driver IC 220 may include a bank of registers 265. These registers 265 may be associated with functions of the dumb display driver IC 220. For example, one register may indicate a color mode and another register may indicate color resolution for the LCD array 215. Thus, by placing appropriate values into the respective registers 265, parameters or characteristics, for example, gamma, scan direction, line/frame inversion mode, partial mode, or similar parameters of the LCD array 215 may be changed. The dumb display driver IC 220 may be referred to as a “dumb” display driver since it does not have any memory to temporarily store data.

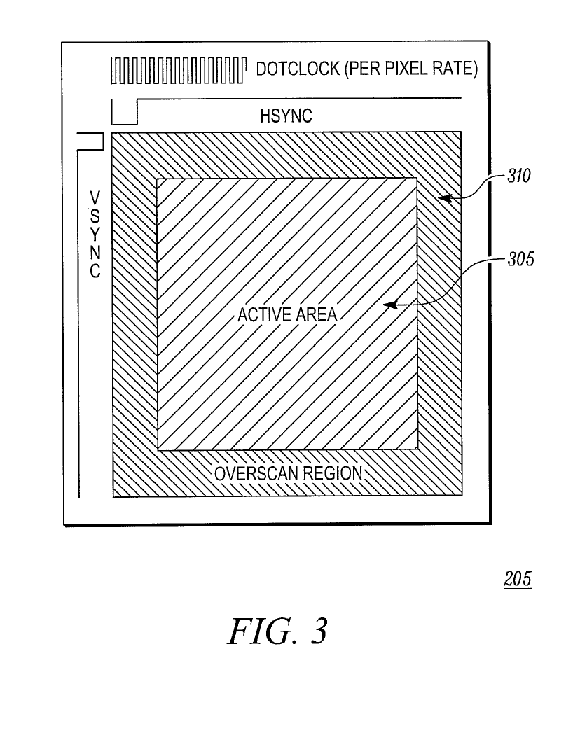

FIG. 3 illustrates the LCD array 215 with an active scan area 305 and an overscan region 310. More particularly, the dumb display driver IC 220 may be configured to reserve an area of the LCD array 215 as the active scan region 305. The active scan region 305 is the viewing area for the user. Bordering the active scan region 305 is an overscan region 315 of the LCD array 215. After each raster scan of a row, the LCD array 215 requires time to recharge associated row driver circuits before the next row is ‘written’. As a result, the overscan region 310 typically does not receive any data.

Returning to FIG. 2, for at least several embodiments, the GPU 210 may be configured to transmit a data message to the registers 265 of the dumb display driver IC 220 over the LCD interface 225. The LCD interface 225 may be implemented as a serial interface conforming to an industry standard, in some embodiments. The serial interface may conform to an inter-integrated circuit (I2C), a Serial Peripheral Interface (SPI) or a plain serial protocol as known to those skilled in the art. More particularly, when the display driver IC 220 is an overscan region 310 of the LCD array 215, the GPU 210 may transmit a data message to the dumb display driver IC 220 over the RGB lines 230, 235, 240. The GPU 210 may package the data message with a precursor string. The precursor string may be a string of bits that will notify the dumb display drive IC 220 that the next series of words are intended for the registers 265. The dumb display driver IC 220 may be configured to receive the data message and write the data message into the registers in response to the detection of the precursor string while the dumb display driver IC 220 is in the overscan region.

In other embodiments, the GPU 210 may be configured to communicate with the registers 265 of the dumb display driver IC 220 during the active scan region 305 (see FIG. 3). More particularly, the GPU 210 may create a data packet configured to contain the data message and a precursor string. The GPU 210 may embed the data packet in a digital image. The digital image is transmitted by the GPU 210 to the dumb display driver IC 220. The dumb display driver IC 220 may be configured to process the data to render the image on the LCD array 215. When the dumb display driver IC 220 detects the precursor string in the embedded digital image, the dumb display driver IC 220 may write the data message to the appropriate register 265. The contents of the registers 265 may then be displayed on the LCD array 215 as appropriate alpha-numeric characters representing the register contents or individual block patterns to represent bit on/off states from the registers directly. Because of the small number of registers in the dumb display driver IC 220 and the relatively infrequent updates that are required for putting this information in the active scan area, one frame should not be noticeable to the user. These embodiments have the added advantage that no changes are needed to existing processors.

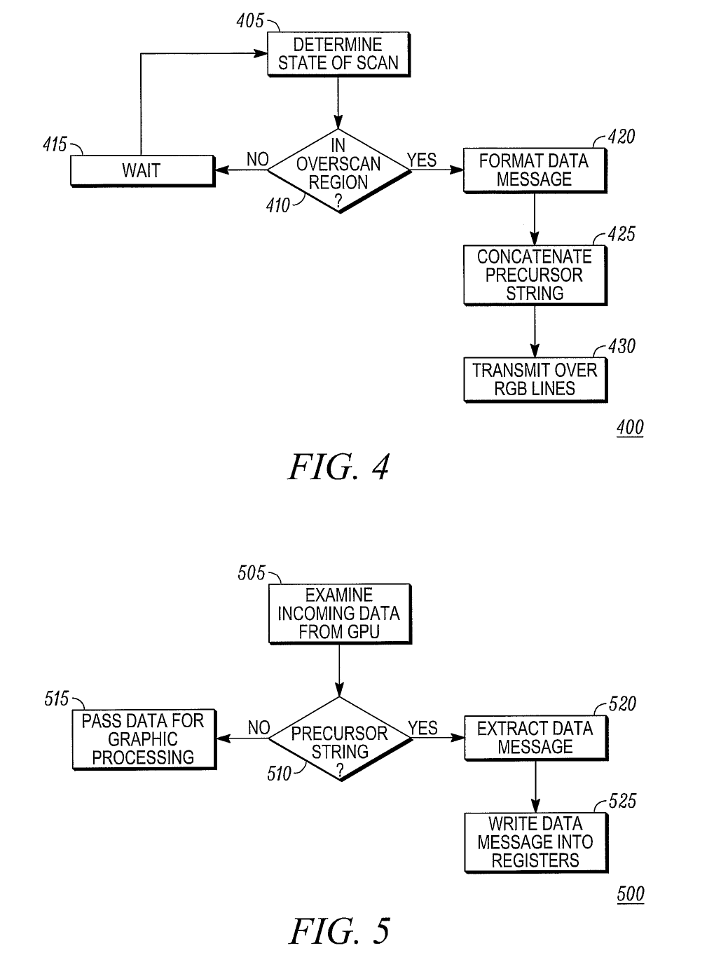

FIG. 4 illustrates a flow diagram 400 implemented by the GPU 210 in accordance with an embodiment. It should be readily apparent to those of ordinary skill in the art that the flow diagram 400 depicted in FIG. 4 represents a generalized schematic illustration and that other steps may be added or existing steps may be removed or modified.

As shown in FIG. 4, in step 405, the GPU 210 may be configured to determine the state of the LCD array. More particularly, the GPU 210 may determine whether the dumb display driver IC 220 has reached the overscan area. As known to those skilled in the art, digital images are typically rendered line-by-line albeit very quickly. A line may start in one side of the overscan region through an active scan region and then to the second side of the overscan region.

In step 410, the GPU 210 may be configured to determine whether the dumb display driver IC 220 is in the overscan region. If the dumb display driver IC 220 is not in the overscan region, the GPU 210 may enter a wait state, in step 415 and proceed to step 405. In other embodiments, the GPU 210 may determine from the current row and column addresses if the dumb display driver IC 220 is in the overscan region.[is this possible]

Otherwise, if the dumb display driver IC 220 is in the overscan region of the LCD array 215, the GPU 210 may be configured to format a data packet for the dumb display driver IC 220, in step 420. More specifically, a data message or payload of memory words may be formed. The memory words are intended for a respective register of the registers 265.

In step 425, the GPU 210 may be configured to concatenate or append a precursor string. The precursor string may be used to indicate to the dumb display driver IC 220 that a data message for the registers 265 is pending.

In step 430, the GPU 210 may be configured to transmit the data packet to the dumb display driver IC 220 over the RGB lines 230, 235, 240. Unlike conventional dumb display drivers and LCD arrays where the RGB lines 230, 235, 240 are left unused during the overscan region, embodiments use the RGB lines 230, 235, 240 as a communication channel to the registers of the dumb display driver IC. Thus, communication may be effectuated without the addition of signal lines.

FIG. 5 illustrates a flow diagram 500 implemented by the dumb display driver IC 220 in accordance with an embodiment. It should be readily apparent to those of ordinary skill in the art that the flow diagram 500 depicted in FIG. 5 represents a generalized schematic illustration and that other steps may be added or existing steps may be removed or modified.

As shown in FIG. 5, dumb display driver IC 220 may be configured to process the incoming data stream from the GPU 210, in step 505. More particularly, the dumb display driver IC 220 may search for the precursor string in the incoming data stream, in step 510.

If the dumb display driver IC 220 has not detected the precursor string, the incoming data stream may be processed for display on the LCD array 215. Otherwise, if the dumb display driver IC 220 detects the precursor string while in the overscan region, the dumb display driver IC 220 may be configured to extract the data message from the data stream, in step 520.

In step 525, the dumb display driver IC 220 may be configured to write the appropriate data from the data message into the respective registers 265 of the dumb display driver IC 220.

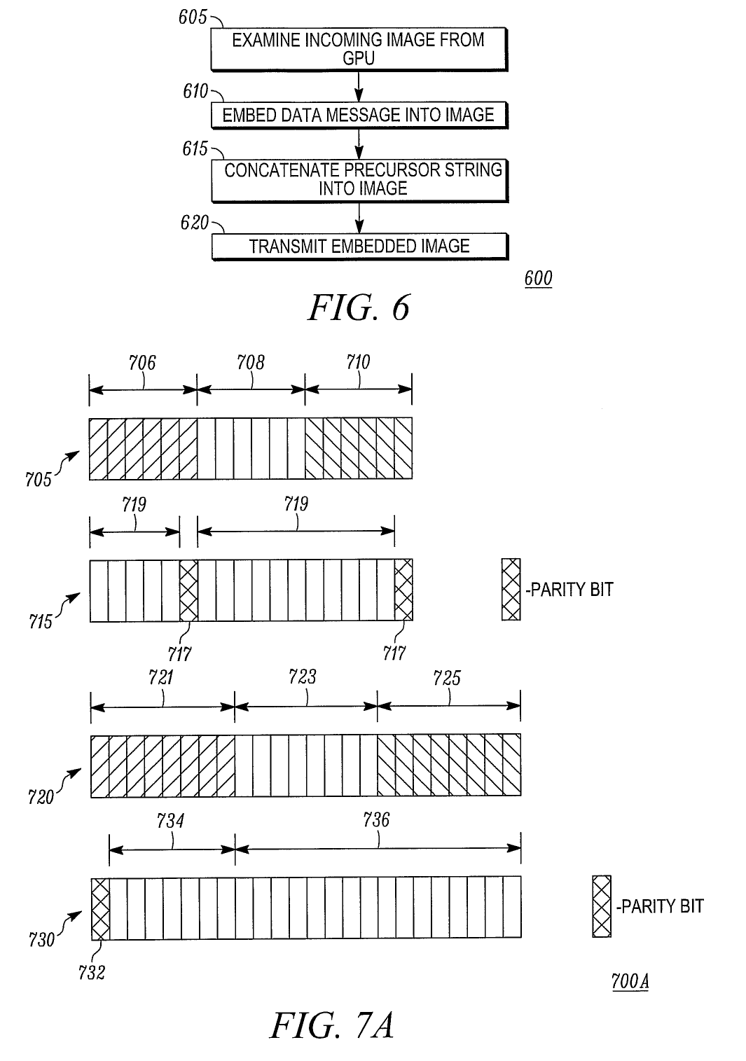

FIG. 6 illustrates a flow diagram 600 implemented by the GPU 210 in accordance with an embodiment. It should be readily apparent to those of ordinary skill in the art that the flow diagram 600 depicted in FIG. 6 represents a generalized schematic illustration and that other steps may be added or existing steps may be removed or modified.

As shown in FIG. 6, the GPU 210 may be initiated to send data to the registers 265 of the dumb display driver IC 220, in step 605. More particularly, a user or an application may desire to implement a change in the LCD array 215. Accordingly, the GPU 210 may receive the appropriate data to program the registers. For example, this data related to configuration of the LCD array 215 may be stored in memory 125.

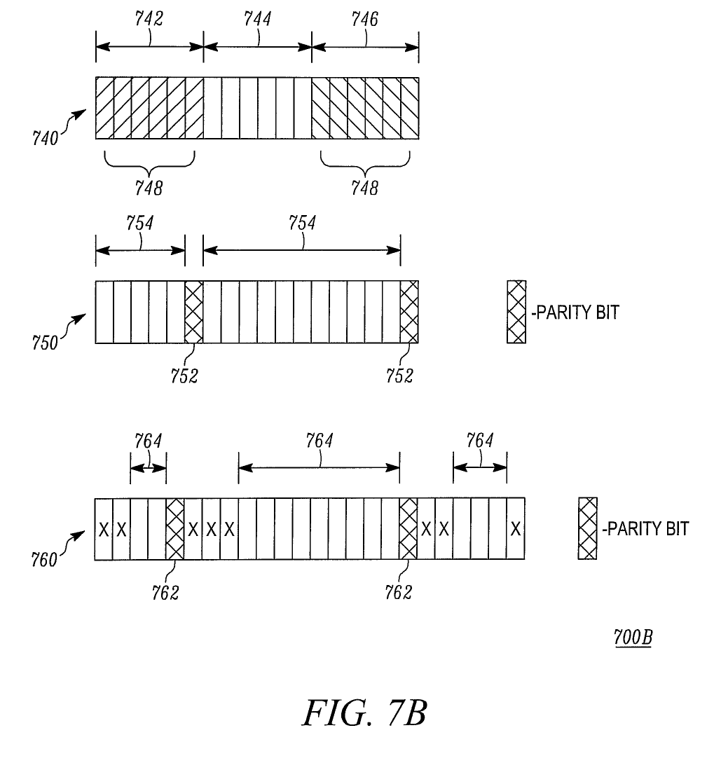

In step 610, the GPU 210 may be configured to embed the data into a digital image. The image may also be retrieved from memory 125 or may be received from another mobile terminal. The formats of the embedded data in various embodiments are depicted in FIGS. 7A-B.

FIG. 7A depicts possible formats for data that are transmitted to the dumb display IC 220 embedded in an image for an 18 bit RGB display in accordance with various embodiments. As shown in FIG. 7A, format 705 depicts the normal data word for a pixel in the 18-bit LCD array (e.g., LCD array 215). Format 705 may assign 6 bits to red 706, 6-bits for green 708 and 6-bits for blue 710. For example, a pixel may be formatted according to format 705 to specify a color, which is transmitted from the GPU 210 to the dumb display driver IC 220.

Format 715 depicts an exemplary format to embed a command/programming data in an image to program the 16-bit registers of the dumb display driver IC 220. Bit position six and bit position eighteen may be configured to be parity bits 717, and the rest of the positions (16-bits) are available for programming as a register command field 719. Accordingly, for example, data formatted according to format 715 may be transmitted to the dumb display driver IC 220 embedded in an image. For format 715, all the registers are written in order starting from the first register and any unlisted registers are skipped.

Format 720 may be configured for pixels that are transmitted to the dumb display IC driver 210 for a 24 bit RGB display in accordance with various embodiments. Format 720 depicts the normal data word for the 24-bit RGB array (e.g., LCD array 215). Format 720 may assign the most significant 8 bits to red 721, the second most significant 8 bits for green 723 and the least significant 8 bits for blue 725. Accordingly, pixels of an image may be formatted specifying the color, which are then driven on an LCD array by the dumb display driver IC 220.

Format 730 may depict a format to program the 16-bit registers of the dumb display driver IC 220 for a 24-bit RGB display. Bit position one may be configured to be a parity bit 732. Bit positions two through eight may be configured to specify an index field 734. The rest of the bit positions 9-24 (16-bits) may be available for programming as a register command field 736. Accordingly, for example, command/programming data may be formatted according to format 730 are then embedded in an image transmitted to the dumb display IC 220.

FIG. 7B illustrates a various embodiments for data packets being transmitted from a 16-bit GPU (e.g., GPU 210) to an 18-bit dumb display driver IC (e.g., dumb display driver IC 220) or an 18-bit GPU accessing 16-bit data. Most conventional LCD arrays 205 are 18-bit displays. However, most data processing systems may be 8, 16, 32-bit wide with memory stored in multiples of 8-bit bytes. Accordingly, the most efficient packing of data from the GPU 210 to the dumb display driver IC 220 is for 16-bit color data. The extra bits from 18-bit to 16-bit may be accounted for by tying the most significant bit and the least significant bit of the red and blue colors together. The accompanying lines on the GPU interface 245 may be physically tied together for a GPU with 16 outputs interfacing a display with 18 inputs or for a GPU that outputs 18-bits while accessing 16 bit data.

As shown in FIG. 7B, similar to format 705 shown in FIG. 7A, format 740 depicts a 16-bit truncated data word for a combination of interfacing 18-bit LCD array with a 16-bit GPU or an 18-bit output GPU accessing 16-bit data. Format 740 may assign the most significant 6 bits to a red field 742, the second most significant 6 bits for a green field 744 and the least significant 6 bits for a blue field 746. In format 740, the most significant bit (MSB) and the least significant bit (LSB) of the red field 742 are tied together 748 as well as the MSB and LSB of the blue field 746. Accordingly, pixels of an image may be encoded to format 740 to be transmitted from the GPU 210 to the dumb display IC 220 during an active scan.

Format 750 depicts a format for embedding a command/programming data in an image to program the 16-bit registers of the dumb display driver IC 220 for either 18-bit LCD array interfacing with a 16-bit GPU or an 18-bit output GPU accessing 16-bit data. Bit position six and bit position eighteen may be configured to be parity bits 752, and the rest of the positions (16-bits) are available for programming as a register command field 754. The parity bits may not be required but are desirable for error checking. Accordingly, for example, pixels may be encoded according to format 750 to be transmitted to the dumb display IC 220 during an active scan. For format 750, all the registers are written in order starting from the first register and any unlisted registers may be skipped.

As an alternative to format 750, format 760 may be utilize to format command/programming data. Format 750 includes chameleon bits 752 at bit positions one, two, six, seven, eight, thirteen, fourteen and eighteen. These chameleon bits 752 may be used to program to match the surrounding pixels on order to better hide the appearance of the embedded command/programming data. Format 760 also includes parity bits 754 at bit positions five and twelve but they are not required. However, the parity bits are desirable for error checking. The rest of the bit may be used as an 8-bit register command field 754. However, sending only eight bits of command/programming data may require sending twice as many pixels to fill the registers.

Returning to FIG. 6, in step 615, the GPU 210 may be configured to concatenate or append a precursor string into the image. More specifically, the precursor string indicates to the dumb display driver 210 that a data message for the registers is pending.

In step 620, the GPU 210 may drive the embedded image onto the active scan area of the LCD array 215.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of communicating with a plurality of registers in a display driver integrated circuit, the method comprising:
providing for a data message; and
driving the data message over color select lines of the display driver integrated circuit in response to the display driver integrated circuit being in an overscan condition.

2. The method of claim 1, wherein the overscan condition indicates that a horizontal sync signal and a vertical sync signal are high.

3. The method of claim 1, further comprising modifying a graphic processor unit to drive the data message over the color select lines.

4. The method of claim 1, wherein the data message is driven in a serial data protocol.

5. The method of claim 1, further comprising sensing a state of at least one status line of the display driver integrated circuit.

6. The method of claim 1, further comprising attaching a precursor sequence to the data message.

7. The method of claim 6, further comprising:
detecting the precursor sequence; and
unblocking writing to the plurality of registers in the display driver integrated circuit in response to the detection of the precursor sequence.

8. The method of claim 1, further comprising adding communication lines to the display driver integrated circuit.

9. The method of claim 8, further comprising receiving data from the plurality of registers in the display driver integrated circuit over the communication lines in response to a read request.

10. A method of communicating with a plurality of registers in a display driver integrated circuit, the method comprising:
embedding a data message into a digital image to create an embedded image;
transmitting the embedded image to the display driver integrated circuit; and
processing the embedded image to transfer the data message to the respective registers of the display driver integrated circuit.

11. The method of claim 10, further comprising transmitting a precursor message in the embedded message.

12. The method of claim 11, further comprising:
detecting the precursor message in the embedded image and
unblocking writing in the plurality of registers in the display driver integrated circuit in response to the detection of the precursor message.

13. A system for communication with a plurality of registers, the system comprising:
a graphic processing unit configured to process digital images, wherein the graphic processing unit is configured to embed a data message into a digital image to create an embedded image and transmit the embedded image; and
a display driver integrated circuit coupled to the graphic processing unit including a plurality of registers, the display driver integrated circuit configured to display images in response to data from the graphic processing unit, wherein the display driver integrated circuit is configured to process the embedded image to write the data message to a respective register of the plurality of registers.

14. The system of claim 13, wherein the graphic processing unit is further configured to embed a precursor message in the digital image.

15. The system of claim 14, wherein the display driver integrated circuit is configured to detect the precursor message in the embedded image and to enable writing of the data message to the respective register of the plurality of registers in the display driver integrated circuit.

16. The system of claim 15, further comprising a liquid crystal display coupled to the display driver integrated circuit, wherein the display driver integrated circuit is configured to display the contents of the plurality of registers on the liquid crystal display.

17. A system for communicating with a plurality of registers, the system comprising:
a graphic processing unit configured to process digital images;
a display driver integrated circuit configured to interface with the graphic processing unit; and
a standard interface including color select lines, the standard interface conforming with at least one standard and providing a communication channel between the graphic processing unit and the display driver integrated circuit, wherein the graphic processing unit is configured to transmit a data message over the color select lines of the standard interface to the display driver integrated circuit in response to the display driver integrated circuit being in a predefined state.

18. The system of claim 17, wherein the graphic processing unit is configured to embed a precursor message in the data message and the display driver integrated circuit is configured to detect the precursor message in the data image and unblock writing of the data message in the respective register of the plurality of registers in the display driver integrated circuit.

19. The system of claim 17, wherein the predefined state is an overscan condition where a horizontal sync signal and a vertical sync signal are high.
